(19) United States
(12) Patent Application Publication
(10) Pub. No.: US 2026/0152586 A1
(43) Pub. Date: Jun. 4, 2026

(54) HIGHLY DISPERSIBLE PVDF, PREPARATION METHOD THEREFOR AND USE THEREOF

(71) Applicant: RUYUAN DONGYANGGUANG FLUORINE RESIN CO., LTD., Shaoguan (CN)

(72) Inventors: Huajun YANG, Shaoguan (CN); Bingfa ZHENG, Shaoguan (CN); Jingwen DAI, Shaoguan (CN); Tangjian CHENG, Shaoguan (CN); Qiongfeng CHEN, Shaoguan (CN)

(21) Appl. No.: 19/482,864

(22) PCT Filed: Jun. 15, 2023
(86) PCT No.: PCT/CN2023/100359

§ 371 Date: Nov. 10, 2025

(30) Foreign Application Priority Data
Nov. 18, 2022 (CN) 202211447148.0

(51) Int. Cl. C08F 14/22; C08F 2/24; H01M 4/02; H01M 4/58; H01M 4/62

(52) U.S. Cl. CPC C08F 14/22; C08F 2/24; H01M 4/623; H01M 2004/028; H01M 4/5825

(57) ABSTRACT

A highly dispersible PVDF, a preparation method therefor and a use thereof. The highly dispersible PVDF has a weight average molecular weight of 700,000 to 900,000, a molecular weight distribution of 1.5 to 3.5, and a crystallinity of 30% to 50%.

### CROSS-REFERENCE TO RELATED APPLICATIONS

This application is a National Stage Application of International Application no. PCT/CN2023/100359 filed on Jun. 15, 2023, which claims priority to Chinese Patent Application No. 202211447148.0 filed on Nov. 18, 2022, the entire contents of both of which are hereby incorporated by reference.

### FIELD OF TECHNOLOGY

The present application relates to the technical field of a lithium iron phosphate battery, and in particular to a highly dispersible polyvinylidene fluoride (PVDF), a preparation method therefor and a use thereof.

### BACKGROUND

In recent years, lithium iron phosphate batteries have accounted for a higher proportion in power battery installations due to their high safety, high cycle performance, good high-temperature performance, low cost and environmental friendliness. Mainstream preparation processes for lithium iron phosphate are divided into a solid phase method and a liquid phase method. The solid phase method is relatively simple and technologically mature, and is currently applied to large scale production. However, it has drawbacks, such as a poor product uniformity and a relatively low electrochemical performance of a resulting material. The liquid phase method is technically demanding, yielding products with small particle sizes, excellent uniformity and superior electrochemical performance. Currently, preparing lithium iron phosphate through the liquid phase method is a mainstream direction of future technological development. A binder currently used for a dispersion of a lithium iron phosphate positive electrode system is mainly a polyvinylidene fluoride (PVDF), typically a homopolymer PVDF. For lithium iron phosphate prepared by a general solid phase method, an ordinary PVDF can generally provide a good dispersing ability. However, for nano-scale lithium iron phosphate prepared by the liquid phase method, it is difficult for an ordinary PVDF on a market to provide the good dispersing ability, and a resulting slurry has large viscosity rebound, a severe gelation phenomenon and a low solid content, failing to meet demands of industry technological development.

The prior art provides a lithium-ion battery positive electrode binder and a lithium-ion battery. It primarily involves compounding a high molecular weight PVDF with a medium molecular weight PVDF to obtain a binder, aiming to reduce an amount of a PVDF binder used in a nano lithium iron phosphate system and improve an electrical performance. However, it does not solve problems of large viscosity rebound and poor dispersibility of a lithium iron phosphate slurry prepared by the liquid phase method.

### SUMMARY

The technical problem to be solved by the present application is to solve problems of large viscosity rebound and poor dispersibility of a slurry in an existing lithium iron phosphate system prepared by a liquid phase method, and provide a highly dispersible PVDF. The highly dispersible polyvinylidene fluoride (PVDF), as a binder, is able to mitigate a viscosity rebound problem of a slurry in a nano lithium iron phosphate system prepared by the liquid phase method, increase an overall solid content of the slurry, and meet needs of industrial technological development.

Another object of the present application is to provide a preparation method for the highly dispersible PVDF.

Another object of the present application is to provide a use of the highly dispersible PVDF in a preparation of a positive electrode slurry of a lithium iron phosphate battery.

Another object of the present application is to protect a positive electrode slurry.

The above-mentioned objects of the present application are achieved by the following technical solutions:

A highly dispersible PVDF is provided, which has a weight average molecular weight Mw of 700,000 to 900,000, a molecular weight distribution of 1.5 to 3.5, and a crystallinity of 30% to 50%.

It should be noted that:

A molecular weight and the crystallinity of the PVDF of the present application may be detected by a conventional detection method in the art.

A molecular weight distribution of a PVDF affects its dispersibility and bonding property. A board distribution leads to a large quantity of small molecules and a poor bonding performance. An excessively narrow distribution leads to a poor dispersibility of a slurry.

Meanwhile, the crystallinity of the PVDF not only affects its dispersibility but also affects a peel strength and an electrode plate flexibility during its application. A high crystallinity generally leads to a great peel strength and a poor electrode plate flexibility. A low crystallinity leads to a good electrode plate flexibility and a low peel strength.

By controlling the molecular weight distribution and the crystallinity of the PVDF, the present application can obtain the highly dispersible PVDF and optimize an bonding property of the PVDF, ensuring the peel strength and the electrode plate flexibility in its application.

Furthermore, the PVDF has a weight average molecular weight Mw of 700,000 to 900,000, a molecular weight distribution of 2.0 to 2.6, and a crystallinity of 40% to 45%.

The highly dispersible PVDF of the present application may be prepared by a emulsion process.

The present application also specifically protect a preparation method for the highly dispersible PVDF, which includes the following steps:

evenly stirring water and an emulsifier in an inert atmosphere with an oxygen content of ≤15 ppm, raising a temperature to 50° C. to 100° C., adding a VDF monomer and initially adding an initiator and a chain transfer agent to initiate a reaction at a reaction pressure of 2.0 MPa to 6.5 MPa, supplementing the initiator and the chain transfer agent when a reaction amount is 20%, 40% and 70% respectively, continuing the reaction until a predetermined reaction amount is reached, terminating the reaction, purifying, drying and crushing a resulting product to obtain the highly dispersible PVDF.

It should be noted that:

The PVDF prepared by the present application exhibits excellent dispersibility and stability for a lithium iron phosphate system, particularly to nano-scale lithium iron phosphate prepared by a liquid phase method, enabling a preparation of a high-solid-content lithium battery positive electrode slurry.

The emulsifier of the present application may be a fluorine-free surfactant conventionally used in the art, and in one embodiment is a vinylpyrrolidone polymer. The present application uses the vinylpyrrolidone polymer as the emulsifier for an emulsion polymerization, which has characteristics of environmental friendliness and low cost.

In the present application, the initiator and the chain transfer agent are added in batches, which can better control the molecular weight distribution of the PVDF. In a specific embodiment, the following addition method may be adopted:

The initiator and the chain transfer agent are initially added at an amount of 40% of a total usage amount, and they are supplemented at an amount of 20% of the total usage amount when the reaction amount reaches 20%, 40% and 70% respectively, in three portions.

The reaction amount of 20% means that 20% of a reactant, on a stoichiometric basis, completed a reaction process during a reaction. The reaction amount of 40% means that 40% of the reactant, on the stoichiometric basis, completed the reaction process during the reaction. The reaction amount of 70% means that 70% of the reactant, on the stoichiometric basis, completed a reaction process during a the reaction.

In a specific embodiment, the emulsifier of the present application is the vinylpyrrolidone polymer, and its usage amount is 0.05% to 0.2% of a mass of the VDF monomer.

It should be noted that:

During a polymerization of the PVDF, vinylpyrrolidone also participates in a chain transfer action, thereby introducing a vinylpyrrolidone molecular chain into a PVDF molecular chain. The vinylpyrrolidone polymer can play a dispersing effect on lithium iron phosphate and a conductive agent.

Furthermore, a molecular weight of the vinylpyrrolidone polymer is 1,000 to 300,000.

Furthermore, the molecular weight of the vinylpyrrolidone polymer is 2,000 to 50,000.

Furthermore, the molecular weight of the vinylpyrrolidone polymer is 5,000 to 10,000.

It should be noted that:

The vinylpyrrolidone polymer of the present application may be a vinylpyrrolidone homopolymer and/or a vinylpyrrolidone copolymer.

The vinylpyrrolidone copolymer is a polymer polymerized from a vinylpyrrolidone monomer and another comonomer, such as a vinylpyrrolidone-ethylene copolymer, a vinylpyrrolidone-vinyl acetate copolymer and a vinylpyrrolidone-acrylic acid copolymer.

When the molecular weight of the vinylpyrrolidone polymer is too high, its water solubility is poor, which easily leads to emulsion instability. Conversely, when the molecular weight of the vinylpyrrolidone polymer is too small, the emulsion stability is also poor. That is, both excessively high and excessively low molecular weights cause instability of a PVDF emulsion, resulting in a non-uniform performance of the PVDF.

In a specific embodiment, the usage amount of the initiator in the present application is 0.01% to 1% of a mass of the VDF monomer.

It should be noted that:

The initiator of the present application may be an initiator conventionally used in the art, for example, a persulfate such as sodium persulfate, potassium persulfate and ammonium persulfate.

In a specific embodiment, the usage amount of the chain transfer agent in the present application is 0.01% to 1% of a mass of the VDF monomer.

It should be noted that:

The chain transfer agent of the present application may be a chain transfer agent conventionally used in the art, for example, it may be one or more of ethanol, ethyl acetate, acetone, and diethyl malonate.

The present application also specifically protects a use of the highly dispersible PVDF in preparing a positive electrode slurry of a lithium iron phosphate battery.

The highly dispersible PVDF of the present application exhibits an excellent dispersibility for lithium iron phosphate prepared by the solid phase method and lithium iron phosphate prepared by the liquid phase method, and particularly for the lithium iron phosphate prepared by the liquid phase method. It can be widely applied to the preparation of lithium iron phosphate battery positive electrode slurries and extensively utilized in a field of lithium iron phosphate batteries.

The present application also specifically protects a positive electrode slurry, the positive electrode slurry includes an electrode material and a solvent, the electrode material includes the high dispersible PVDF with a mass percentage of 2% to 3%.

In a specific embodiment, constituent components of the positive electrode slurry of the present application may refer to the following:

The positive electrode slurry includes the electrode material and the solvent, where the electrode material includes 1.5% PVDF, 1% conductive agent, and 97.5% nano-scale lithium iron phosphate, the solvent is NMP (N-methylpyrrolidone), and a solid content of the slurry is 70%.

The above-mentioned nano-scale lithium iron phosphate may be a conventional nano-scale lithium iron phosphate in the art, that is, a primary particle of lithium iron phosphate has a nano-scale average particle size in one dimension, and generally has an average primary particle size at 30-300 nm.

A specific highly dispersible PVDF is added in the positive electrode slurry of the present application as a binder. This highly dispersible PVDF provides an excellent dispersion capability for the positive electrode slurry, thus the positive electrode slurry has a good stability, and its viscosity rebound is significantly reduced, avoiding an occurrence of a gelation phenomenon. A solid content of the positive electrode slurry is greatly increased, the solid content of the positive electrode slurry can reach 55% to 75%, which meets requirements of industry technological development.

### BRIEF DESCRIPTION OF DRAWINGS

FIG. 1 is a schematic diagram illustrating a stability effect of a positive electrode slurry prepared in Example 1;

FIG. 2 is a schematic diagram illustrating a stability effect of a positive electrode slurry prepared in Comparative Example 1; and

FIG. 3 is a schematic diagram illustrating a stability effect of a positive electrode slurry prepared in Comparative Example 2.

### DETAILED DESCRIPTION

The present application will be further described below with reference to specific examples, but the examples are not intended to limit the present application in any form. Unless otherwise indicated, raw material and reagents employed in the examples of present application are conventionally purchased raw materials and reagents.

### Example 1

A highly dispersible polyvinylidene fluoride (PVDF) with a weight average molecular weight Mw of 826,000, a molecular weight distribution of 2.57 and a crystallinity of 42.5% was provided.

A preparation method for the highly dispersible PVDF in Example 1 was as follows:

105 kg of deionized water and 36 g of an emulsifier were added into a 150 L high pressure reactor. A high-purity nitrogen gas replacement was conducted until an oxygen content in the reactor was smaller than 15 ppm. A stirring was started at a stirring frequency of 50%. The reactor was heated to 80° C., then a VDF monomer was added into the reactor until a reactor pressure was 5.5 MPa. An initiator ammonium persulfate and a chain transfer agent diethyl malonate were initially added to initiate the reaction. The initiator and the chain transfer agent were supplemented when a reaction amount reached 20%, 40% and 70%, respectively. The reaction was continued. When the reaction amount reached 36 kg, the reaction was terminated. An obtained emulsion was filtered, washed, dried and crushed to obtain a PVDF powder. An initial adding amount of the initiator and the chain transfer agent was 40% of a total usage amount. When the reaction amount reached 20%, 40% and 70%, respectively, the initiator and the chain transfer agent were supplemented in a supplementing amount equal to 20% of the total usage amount, in three portions.

The emulsifier was polyvinylpyrrolidone with a molecular weight of 5,000, and a usage amount of the emulsifier was 0.1% of a mass of the VDF monomer.

A usage amount of the initiator was 0.04% of the mass of the VDF monomer.

A usage amount of the chain transfer agent was 0.06% of the mass of the VDF monomer.

### Example 2

A highly dispersible PVDF with a weight average molecular weight Mw of 802,000, a molecular weight distribution of 2.35, and a crystallinity of 41.6% was provided.

A preparation method for the highly dispersible PVDF in Example 2 was as follows:

105 kg of deionized water and 18 g of an emulsifier were added into a 150 L high pressure reactor. A high-purity nitrogen gas replacement was conducted until an oxygen content in the reactor was smaller than 15 ppm. A stirring was started at a stirring frequency of 50%. The reactor was heated to 85° C., then a VDF monomer was added into the reactor until a reactor pressure was 3.6 MPa. An initiator potassium persulfate and a chain transfer agent ethyl acetate were initially added to initiate the reaction. The initiator and the chain transfer agent were supplemented when a reaction amount was 20%, 40% and 70%, respectively. The reaction was continued. When the reaction amount reached 36 kg, the reaction was terminated. An obtained emulsion was filtered, washed, dried and crushed to obtain a PVDF powder. An initial adding amount of the initiator and the chain transfer agent was 40% of a total usage amount. When the reaction amount reached 20%, 40% and 70%, respectively, the initiator and the chain transfer agent were supplemented in a supplementing amount equal to 20% of the total usage amount, in three portions.

The emulsifier was polyvinylpyrrolidone with a molecular weight of 10,000, and a usage amount of the emulsifier is 0.05% of a mass of the VDF monomer.

A usage amount of the initiator was 0.08% of the mass of the VDF monomer.

A usage amount of the chain transfer agent was 0.1% of the mass of the VDF monomer.

### Example 3

A highly dispersible PVDF with a weight average molecular weight Mw of 755,000, a molecular weight distribution of 2.39 and a crystallinity of 43.6% was provided.

A preparation method for the highly dispersible PVDF in Example 3 was as follows:

105 kg of deionized water and 72 g of an emulsifier were added into a 150 L high pressure reactor. A high-purity nitrogen gas replacement was conducted until an oxygen content in the reactor was smaller than 15 ppm. A stirring was started at a stirring frequency of 50%. The reactor was heated to 90° C., then a VDF monomer was added into the reactor until a reactor pressure was 3.6 MPa. An initiator potassium persulfate and a chain transfer agent ethyl acetate were initially added to initiate the reaction. The initiator and the chain transfer agent were supplemented when a reaction amount was 20%, 40% and 70%, respectively. The reaction was continued. When the reaction amount reached 36 kg, the reaction was terminated. An obtained emulsion was filtered, washed, dried and crushed to obtain a PVDF powder. An initial adding amount of the initiator and the chain transfer agent was 40% of a total usage amount. When the reaction amount reached 20%, 40% and 70%, respectively, the initiator and the chain transfer agent were supplemented in a supplementing amount equal to 20% of the total usage amount, in three portions.

The emulsifier was a vinylpyrrolidone-vinyl acetate copolymer with a molecular weight of 1,000, and a usage amount of the emulsifier was 0.2% of a mass of the VDF monomer.

A usage amount of the initiator was 0.8% of the mass of the VDF monomer.

A usage amount of the chain transfer agent was 0.5% of the mass of the VDF monomer.

### Example 4

A highly dispersible PVDF with a weight average molecular weight Mw of 789,000, a molecular weight distribution of 2.15 and a crystallinity of 40.8% was provided.

A preparation method for the highly dispersible PVDF in Example 4 was as follows:

105 kg of deionized water and 36 g of an emulsifier were added into a 150 L high pressure reactor. A high-purity nitrogen gas replacement was conducted until an oxygen content in the reactor was smaller than 15 ppm. A stirring was started at a stirring frequency of 50%. The reactor was heated to 90° C., then a VDF monomer was added into the reactor until a reactor pressure was 3.6 MPa. An initiator potassium persulfate and a chain transfer agent ethyl acetate were initially added to initiate the reaction. The initiator and the chain transfer agent were supplemented when a reaction amount was 20%, 40% and 70%, respectively. The reaction was continued. When the reaction amount reached 36 kg, the reaction was terminated. An obtained emulsion was filtered, washed, dried and crushed to obtain a PVDF powder. An initial adding amount of the initiator and the chain transfer agent was 40% of a total usage amount. When the reaction amount reached 20%, 40% and 70%, respectively, the initiator and the chain transfer agent were supplemented in a supplementing amount equal to 20% of the total usage amount, in three portions.

The emulsifier was a vinylpyrrolidone-acrylic acid copolymer with a molecular weight of 50,000, and a usage amount of the emulsifier was 0.1% of a mass of the VDF monomer.

A usage amount of the initiator was 0.5% of the mass of the VDF monomer.

A usage amount of the chain transfer agent was 0.1% of the mass of the VDF monomer.

### Example 5

A highly dispersible PVDF with a weight average molecular weight Mw of 896,000, a molecular weight distribution of 2.56 and a crystallinity of 42.9% was provided.

A preparation method for the highly dispersible PVDF in Example 5 was as follows:

105 kg of deionized water and 21.6 g of an emulsifier were added into a 150 L high pressure reactor. A high-purity nitrogen gas replacement was conducted until an oxygen content in the reactor was smaller than 15 ppm. A stirring was started at a stirring frequency of 50%. The reactor was heated to 85° C., then a VDF monomer was added into the reactor until a reactor pressure was 6.0 MPa. An initiator potassium persulfate and a chain transfer agent ethyl acetate were initially added to initiate the reaction. The initiator and the chain transfer agent were supplemented when a reaction amount was 20%, 40% and 70%, respectively. The reaction was continued. When the reaction amount reached 36 kg, the reaction was terminated. An obtained emulsion was filtered, washed, dried and crushed to obtain a PVDF powder. An initial adding amount of the initiator and the chain transfer agent was 40% of a total usage amount. When the reaction amount reached 20%, 40% and 70%, respectively, the initiator and the chain transfer agent were supplemented in a supplementing amount equal to 20% of the total usage amount, in three portions.

The emulsifier was polyvinylpyrrolidone with a molecular weight of 2,000, and a usage amount of the emulsifier was 0.06% of a mass of the VDF monomer.

A usage amount of the initiator was 0.02% of the mass of the VDF monomer.

A usage amount of the chain transfer agent was 0.02% of the mass of the VDF monomer.

### Example 6

A highly dispersible PVDF with a weight average molecular weight Mw of 687,000, a molecular weight distribution of 2.48 and a crystallinity of 44.3% was provided.

A preparation method for the highly dispersible PVDF in Example 6 was as follows:

105 kg of deionized water and 180 g of an emulsifier were added into a 150 L high pressure reactor. A high-purity nitrogen gas replacement was conducted until an oxygen content in the reactor was smaller than 15 ppm. A stirring was started at a stirring frequency of 50%. The reactor was heated to 90° C., then a VDF monomer was added into the reactor until a reactor pressure was 3.6 MPa. An initiator potassium persulfate and a chain transfer agent ethyl acetate were initially added to initiate the reaction. The initiator and the chain transfer agent were supplemented when a reaction amount was 20%, 40% and 70%, respectively. The reaction was continued. When the reaction amount reached 36 kg, the reaction was terminated. An obtained emulsion was filtered, washed, dried and crushed to obtain a PVDF powder. An initial adding amount of the initiator and the chain transfer agent was 40% of a total usage amount. When the reaction amount reached 20%, 40% and 70%, respectively, the initiator and the chain transfer agent were supplemented in an amount equal to 20% of the total usage amount, in three portions.

The emulsifier was polyvinylpyrrolidone with a molecular weight of 300,000, and a usage amount of the emulsifier was 0.5% of a mass of the VDF monomer.

A usage amount of the initiator was 0.5% of the mass of the VDF monomer.

A usage amount of the chain transfer agent was 0.8% of the mass of the VDF monomer.

### Example 7

### a Preparation for a Positive Electrode Slurry

682.5 g of nano-scale lithium iron phosphate DY-3, 7 g of a conductive agent (SP) and 10.5 g of PVDF were mixed by a roller mixer for 1 hour, then a resulting mixture was added in a 5 L dual planet mixer, and 300 g of N-methylpyrrolidone (NMP) was added in the 5 L dual planet mixer, then a high speed stirring at 1500 revolutions per minute was performed for 2 hours to synthesize a slurry.

### a Preparation for a Positive Electrode Plate

The slurry was uniformly coated on both sides of a 12 μm thick aluminum foil using a scraper, then baked in an air blast oven at 100° C. for 30 minutes. An areal density of a single-side coating is 220 g/m² and an areal density of a double-side coating is 440 g/m². Then it was subjected to a rolling process using a roller press, with a compacted density controlled at 2.48 g/cm3, to obtain the positive electrode plate.

Positive electrode slurries and positive electrode plates were prepared with the PVDF of Examples 1-6.

### Comparative Example 1

### a Preparation for a Positive Electrode Slurry

682.5 g of nano-scale lithium iron phosphate DY-3, 7 g of a conductive agent (SP) and 10.5 g of a commercial binder 1 were mixed by a roller mixer for 1 hour, then a resulting mixture was added in a 5 L dual planet mixer, and 300 g of N-methylpyrrolidone (NMP) was added in the 5 L dual planet mixer, then a high speed stirring at 1500 revolutions per minute was performed for 2 hours to synthesize a slurry.

The commercial binder 1 has a weight average molecular weight of 987,000, a molecular weight distribution of 1.89, a melting point of 164.2° C. and a crystallinity of 43.9%.

In the same manner as in Example 7, a positive electrode slurry was prepared, and a viscosity test and an electrode plate test were conducted.

### Comparative Example 2

### a Preparation for a Positive Electrode Slurry

682.5 g of nano-scale lithium iron phosphate DY-3, 7 g of a conductive agent (SP) and 10.5 g of a commercial binder 2 were mixed by a roller mixer for 1 hour, then a resulting mixture was added in a 5 L dual planet mixer, and 300 g of N-methylpyrrolidone (NMP) was added in the 5 L dual planet mixer, then a high speed stirring at 1500 revolutions per minute was performed for 2 hours to synthesize a slurry.

The commercial binder 2 has a weight average molecular weight of 62,3000, a molecular weight distribution of 2.12, a melting point of 163.4° C. and a crystallinity of 42.1%.

In the same manner as in Example 7, a positive electrode slurry was prepared, and a viscosity test and an electrode plate test were conducted.

### Result Test

Viscosities of positive electrode slurries of the above-mentioned Examples and Comparative Examples were tested, and electrical properties and peel strengths of prepared electrode plates were tested. A specific test method was as follows:

### Positive Electrode Slurry Viscosity Test

120 g of a slurry was added in a 150 ml beaker, sealed by a sealing film and allowed to stand at 25±0.2° C. in a water bath for 1 hour. A viscosity test was conducted using a BROOKFILED rotary viscometer, model DV2TLVTJ0, with a spindle No. 63 at a rotary speed of 12 revolutions per minute, and a viscosity test was conducted to record an initial viscosity. The slurry was stand for 24 hours and 48 hours respectively, and its viscosity value was tested.

### Positive Electrode Plate Peeling Force Test

One side of a 3M VHB double-faced tape (19 mm*60 mm) was adhered to one end of a steel plate. Then a negative electrode plate was cut into a 20 mm*200 mm strip and its positive active layer surface was adhered to the double-faced tape. Under an atmosphere at a temperature of 25° C. and a relative humidity of 50%, a stress was measured when peeling off an aluminum foil toward a 180° direction at a speed of 100 mm/min and defined as a bonding force.

### Positive Electrode Plate Resistance Test

The positive electrode plate was cut into a 1 cm² circular piece using a mold, then a resistance was measured using a resistance tester.

Specific test results are shown in Table 1 below:

TABLE 1

| | Initial | Viscosity of a | Viscosity of a | | |
|---|---|---|---|---|---|
| | Viscosity | Slurry after | Slurry after | Resistance | |
| | of a | standing for 24 | standing for 48 | of an | Peel |
| | Slurry | hours | hours | Electrode | Strength/ |
| Number | (mPa · s) | (mPa · s) | (mPa · s) | Plate/Ω | N/M |
| Example 1 | 11282 | 13854 | 14865 | 1.2 | 18.5 |
| Example 2 | 13864 | 14960 | 16547 | 0.9 | 17.9 |
| Example 3 | 12765 | 14256 | 16120 | 1.6 | 17.4 |
| Example 4 | 13520 | 15155 | 17423 | 2.2 | 19.6 |
| Example 5 | 11685 | 12598 | 13564 | 1.5 | 18.2 |
| Example 6 | 14856 | 16850 | 17956 | 2.8 | 16.9 |
| Compar- | 19548 | Gel | Gel | 7.5 | 14.7 |
| ative | | | | | |
| Example 1 | | | | | |
| Compar- | 16421 | 28569 | Gel | 6.8 | 13.8 |
| ative | | | | | |
| Example 2 | | | | | |

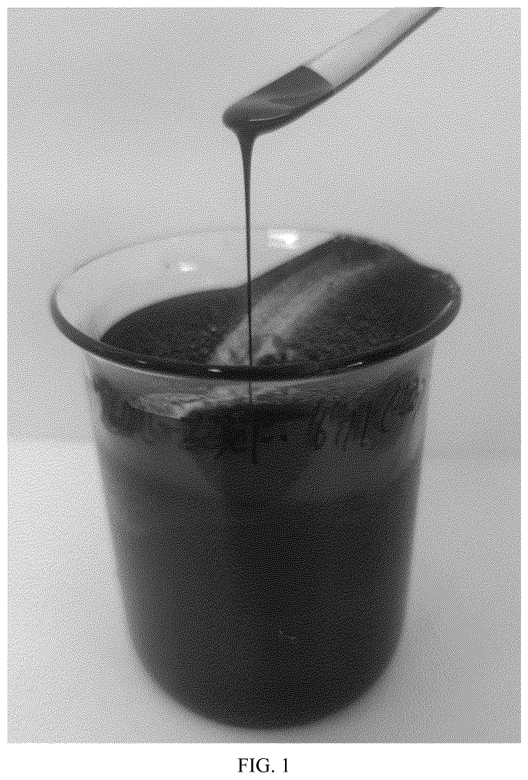

It can be seen from Table 1 above that, the highly dispersible PVDF of the present application exhibits good dispersibility and stability for nano-scale lithium iron phosphate prepared by a liquid phase method. The viscosity of the slurry remains essentially stable compared to the initial slurry viscosity after standing for 24 hours and 48 hours, with the viscosity rebound significantly decreased and no gelation observed. FIG. 1 is a schematic diagram illustrating a stability effect of a positive electrode slurry prepared in Example 1. As shown in FIG. 1, the slurry exhibits good fluidity without gelation, indicating better fluidity and slurry stability. All positive electrode slurries in other Examples exhibit the same effects as shown in FIG. 1. The electrode plate of Examples of the present application exhibits a lower resistance, which can be controlled below 2.8Ω, demonstrating that the PVDF in Examples exhibit excellent dispersibility for both the nano-scale lithium iron phosphate and the conductive agent SP.

Meanwhile, the highly dispersible PVDF of the present application also has good bonding performance, and the peel strength of the positive electrode plate can reach above 16.9 N/M.

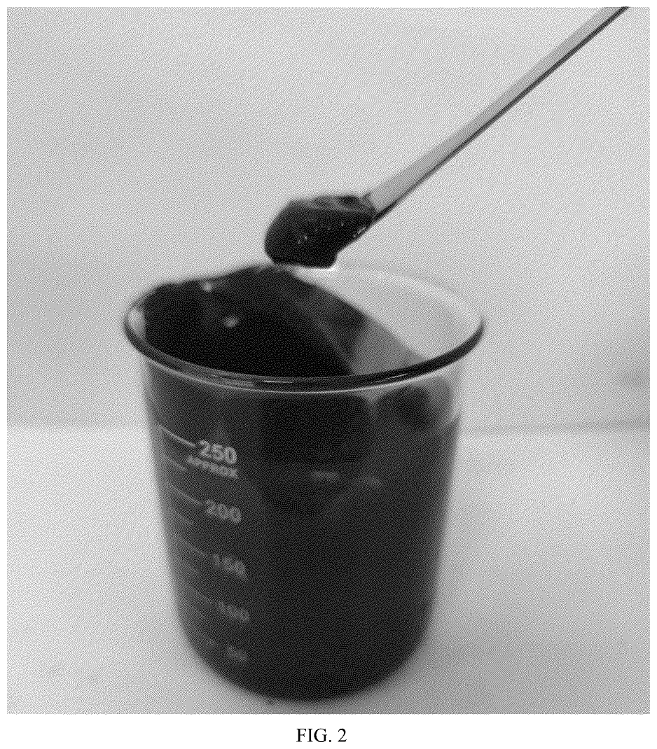

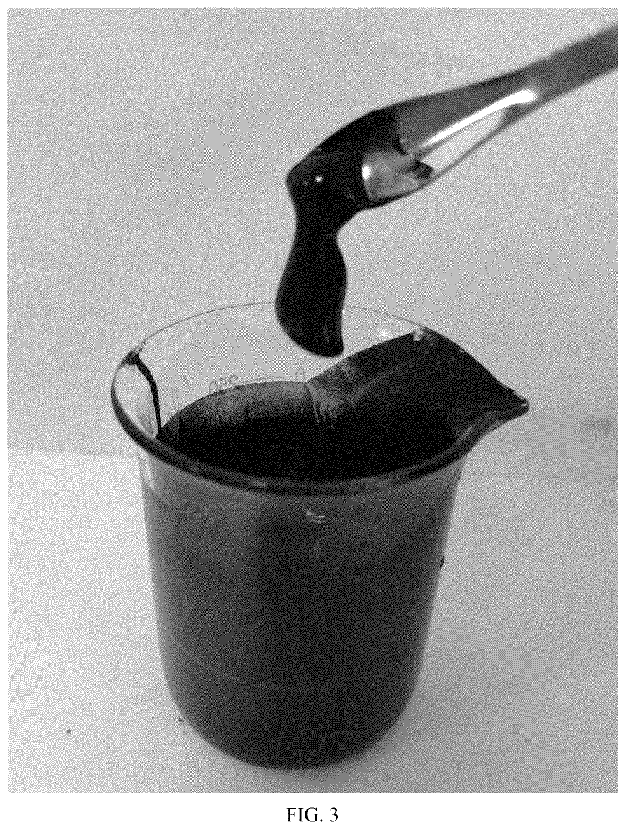

Comparative Example 1 and Comparative Example 2 used two types of binders commonly available in the market for the lithium iron phosphate positive electrode slurry to replace the highly dispersible PVDF of the present application. FIG. 2 is a schematic diagram illustrating a stability effect of a positive electrode slurry prepared in Comparative Example 1, and FIG. 3 is a schematic diagram illustrating a stability effect of a positive electrode slurry prepared in Comparative Example 2. It can be observed that both exhibited the gelation, indicating their poor dispersibility and stability. Moreover, the resistance of the positive electrode plate far exceeded 2.8Ω as achieved in the present application, and bonding performance was inferior to that of the present application, with lower peel strength.

Apparently, the above examples of the present application are merely examples to describe the present application clearly and are not intended to limit the implementation manners of the present application. A person of ordinary skill in the art may further make other changes or variations in a different form on the basis of the above description. Herein, examples are unnecessarily provided for all implementation manners. Any modification, equivalent replacement, improvement and the like made within the spirit and principle of the present application should be included in a scope of protection of the claims of the present application.

1. A highly dispersible polyvinylidene fluoride (PVDF), wherein the PVDF has a weight average molecular weight of 700,000 to 900,000, a molecular weight distribution of 1.5 to 3.5, and a crystallinity of 30% to 50%.

2. A preparation method for the highly dispersible PVDF of claim 1, comprising the following step:
evenly stirring water and an emulsifier in an inert atmosphere with an oxygen content of ≤15 ppm, raising a temperature to 50° C. to 100° C., adding a VDF monomer and initially adding an initiator and a chain transfer agent to initiate a reaction at a reaction pressure of 2.0 MPa to 6.5 MPa, supplementing the initiator and the chain transfer agent when a reaction amount is 20%, 40% and 70% respectively, continuing the reaction until a predetermined reaction amount is reached, terminating the reaction, purifying, drying and crushing a resulting product to obtain the highly dispersible PVDF.

3. The preparation method for the highly dispersible PVDF of claim 2, wherein the emulsifier is a vinylpyrrolidone polymer, and a usage amount of the emulsifier is 0.05% to 0.2% of a mass of the VDP monomer.

4. The preparation method for the highly dispersible PVDF of claim 3, wherein the vinylpyrrolidone polymer has a molecular weight of 1,000 to 300,000.

5. The preparation method for the highly dispersible PVDF of claim 4, wherein the vinylpyrrolidone polymer has a molecular weight of 2,000 to 50,000.

6. The preparation method for the highly dispersible PVDF of claim 2, wherein a usage amount of the initiator is 0.01% to 1% of a mass of the VDF monomer.

7. The preparation method for the highly dispersible PVDF of claim 2, wherein a usage amount of the chain transfer agent is 0.01% to 1% of a mass of the VDF monomer.

8. A use of the highly dispersible PVDF of claim 1 in preparing a positive electrode slurry of a lithium iron phosphate battery.

9. A positive electrode slurry, comprising: an electrode material and a solvent, wherein the electrode material comprises the highly dispersible PVDF of claim 1 with a mass percentage of 2% to 3%.

10. The positive electrode slurry of claim 9, wherein a solid content of the positive electrode slurry is 55% to 75%.
